(19) United States
(12) Patent Application Publication
(10) Pub. No.: US 2012/0322923 A1
(43) Pub. Date: Dec. 20, 2012

(54) FLAME RETARDANT COMPOSITION FOR THERMOPLASTIC MOLDING COMPOUNDS

(75) Inventors: Hendrik Wermter, Eltville (DE); Thomas Futterer, Ingelheim (DE); Sven Fünderich, Norheim (DE)

(73) Assignee: Chemische Fabrik Budenheim KG, Budenheim (DE)

(21) Appl. No.: 13/518,062

(22) PCT Filed: Dec. 29, 2010
(86) PCT No.: PCT/EP2010/070885

§ 371 Date: Aug. 30, 2012

(30) Foreign Application Priority Data
Dec. 31, 2009 (DE) 10 2009 055 434.3

(51) Int. Cl. C08K 5/3492; C08L 67/00

(52) U.S. Cl. 524/100

(57) ABSTRACT

A halogen-free flame retardant composition that can be incorporated well into different synthetic materials, is easily compatible with the polymer matrix and exhibits good flame protection action, without significantly impairing the mechanical and electrical properties of the synthetic material. The flame retardant composition contains at least one component a) selected from the group of nitrogen bases, melamine derivatives, phosphates, pyrophosphates, polyphosphates, organic and inorganic phosphinates, organic and inorganic phosphonates, and derivatives of the above compounds, and at least one component b) selected from phosphorus-containing polyesters, which can be obtained by reacting phosphorus-containing monomers with each other and/or with ester-forming monomers.

The invention concerns a halogen-free flame retardant composition and polymers containing the composition according to the invention.

Halogen-bearing flame retardants, at least in combination with antimony trioxide, are frequently used as flame retardants in plastics, in particular in thermoplastic molding compounds. In the case of a fire such flame retardants admittedly afford good effectiveness, but upon combustion corrosive and sometimes also toxic substances such as for example dioxins and furans, are formed and liberated.

To prevent the occurrence of those toxic substances therefore halogen-free flame retardants have been developed, which are based on metal hydroxides, organic or inorganic phosphates, phosphinates or phosphonates with synergistically acting substances or derivatives of 1,3,5-triazine compounds and mixtures thereof. A disadvantage of those flame retardants however is that they frequently only impart a low level of flame retardant action and cannot be used or can only be conditionally used for employment in plastics, in particular thermoplastic materials and elastomers in the electrical and electronic field as some phosphorus-bearing flame retardants can have an influence on electrical conductivity and thus alter the properties for example of a cable sheathed with a plastic with flame retardant or an electrical component comprising thermoplastic materials with a flame retardant. In addition such flame retardants can also lead to impairment of the mechanical properties of a plastic. Some flame retardants which in other respects are good are also not suitable for use with plastics which contain fillers.

The object of the invention is therefore that of providing a flame retardant composition which can be well incorporated into various plastics, which is well compatible with the polymer matrix and which has a good flame retardant action without substantially adversely affecting the mechanical and electrical properties of the plastic.

According to the invention that object is attained with a halogen-free flame retardant composition which contains

at least one component (a) selected from the group consisting of nitrogen bases, melamine derivatives, phosphates, pyrophosphates, polyphosphates, organic and inorganic phosphinates, organic and inorganic phosphonates and derivatives of the aforementioned compounds, and

at least one component (b) selected from phosphorus-bearing polyesters which can be obtained by reaction of phosphorus-bearing monomers with each other and/or with ester-forming monomers, wherein the phosphorus-bearing monomer is selected from addition products of 9,10-dihydro-9-oxa-10-phospha-phenanthrene-10-oxide (DOPO) and ring-substituted derivatives of 9,10-dihydro-9-oxa-10-phospha-phenanthrene-10-oxide to unsaturated compounds from the group of monovalent and polyvalent carboxylic acids and anhydrides thereof, monovalent and polyvalent alcohols and hydroxycarboxylic acids and wherein the ester-forming monomer is selected from the group consisting of saturated and unsaturated, monovalent and polyvalent alcohols or mixtures thereof, saturated and unsaturated carboxylic acid anhydrides and saturated and unsaturated, monovalent and polyvalent carboxylic acids.

9,10-Dihydro-9-oxa-10-phosphaphenanthrene-10-oxide (DOPO) and the polymeric derivatives thereof are admittedly known as flame retardants in given polyesters, but it has been found that numerous plastics, after the addition of DOPO or polymeric derivatives thereof, can no longer be processed or metered and clog up the machines necessary for processing thereof. Surprisingly a flame retardant composition according to the invention has a flame retardant action which is improved in comparison with the individual components in a multiplicity of different plastics and can be well processed in those plastics. Plastics with the flame retardant composition according to the invention possibly have good mechanical and electrical properties by virtue of a low level of flame retardant loading.

The very good flame retardant action is surprisingly based on the formation of radicals by the component b), which is synergistically supported by different flame retardant mechanisms of the component a). The precise mechanism of the synergistic action of the components a) and b) is however not known. The combination of the components a) and b) leads to advantageous properties both in relation to capability of being incorporated into the plastic and also in regard to the flame retardant properties. A further advantage of the flame retardant composition according to the invention is the low solubility of the component b) contained in the form of a polymer, whereby the risk of the flame retardant composition being washed out or migrating out of a plastic material is markedly reduced.

Preferably the at least one component a) of the halogen-free flame retardant composition is selected from ammonium polyphosphate, ammonium polyphosphate particles which are coated with melamine, melamine resin, melamine derivatives, silanes, siloxanes or polystyrenes and/or which are coated and crosslinked, as well as 1,3,5-triazine compounds, including melamine, melam, melem, melon, ammeline, ammelide, 2-ureidomelamine, acetoguanamine, benzoguanamine, diaminophenyltriazine, melamine salts and adducts, melamine cyanurate, melamine borate, melamine orthophosphate, melamine pyrophosphate, dimelamine pyrophosphate and melamine polyphosphate, oligomeric and polymeric 1,3,5-triazine compounds and polyphosphates of 1,3,5-triazine compounds, guanine, piperazine phosphate, piperazine polyphosphate, ethylene diamine phosphate, pentaerythritol, borophosphate, 1,3,5-trihydroxyethylisocyanaurate, 1,3,5-triglycidylisocyanaurate, triallylisocyanurate and derivatives of the aforementioned compounds.

It has been found that both nitrogen-bearing and also phosphorus-bearing compounds are suitable alone and in combination with each other as component a).

The above-mentioned compounds involve components a) which are stable during processing of the plastic material at high temperatures, for example by extrusion, so that no substantial destruction of those components takes place. It has been found that in that way the processibility of the plastic containing the flame retardant according to the invention is substantially improved and at the same time the flame-retardant action is retained.

Preferably a single component a) is contained in the composition.

In a further embodiment precisely two or more components a) are contained.

In a preferred embodiment of the flame retardant composition according to the invention the at least one component a) is selected from melam, melon, melam, melamine cyanurate, melamine borate, melamine orthophosphate, melamine pyrophosphate, dimelamine pyrophosphate and melamine polyphosphate, ammonium polyphosphate and boron phosphate as well as derivatives thereof. Those components a) already have in themselves a good flame retardant action and enjoy high thermal stability. It has been found that they can also be well incorporated into thermoplastic molding compositions for example by extrusion in combination with component b) at elevated temperatures.

Preferably melamine cyanurate or melamine polyphosphate are used as component a). They are difficult to dissolve in water and a flame retardant containing same is particularly suitable for incorporation into plastics, for example for sheathing conducting structures or as a basis of conducting structures like for example in electronic components.

Particularly preferably at least two different components a) are contained in the halogen-free flame retardant composition, wherein at least one component a) is selected from ammonium polyphosphate and derivatives thereof or melamine phosphate derivatives and at least one other component a) is a nitrogen base different from the first component.

The mixture of those components a) is an intumescent flame retardant. In a fire situation, independently of component b), that mixture forms gases which lead to expansion and foaming up of the material into which they are introduced. Surprisingly the use of such flame retardants together with component b) leads to a further improvement in the flame retardant action.

Examples of such flame retardants, besides the at least one component b), contain ammonium polyphosphate or derivatives thereof or melamine phosphate derivatives and a crust forming agent such as for example pentaerythritol or piperazine derivatives.

In an embodiment a single component b) is contained in the composition.

In an embodiment precisely two or more components b) are contained.

Preferably at least one phosphorus-bearing polyester of the at least one component b) has a mean degree of polymerisation Pₙ of at least 55, preferably between 60 and 250, particularly preferably between 60 and 90.

That polyester with a comparatively high degree of condensation is highly stable in processing in a plastic together with at least one component a) as transesterification reactions are substantially suppressed.

In a preferred embodiment of the invention at least one phosphorus-bearing polyester of the at least one component b) has a mean molecular weight Mₙ of more than 1000 g/mol, preferably between 5000 and 250,000 g/mol, particularly preferably between 25,000 and 100,000 g/mol.

Preferred unsaturated monocarboxylic and dicarboxylic acids for the reaction with addition products of 9,10-dihydro-9-oxa-10-phospha-phenanthrene-10-oxide and ring-substituted derivatives of 9,10-dihydro-9-oxa-10-phospha-phenanthrene-10-oxide for the production of the at least one component b) are sorbic acid, acrylic acid and crotonic acid as well as itaconic acid, maleic acid, fumaric acid, endomethylene tetrahydrophthalic acid, citraconic acid, mesaconic acid and tetrahydrophthalic acid as well as their anhydrides. Itaconic acid, maleic acid and anhydrides thereof are particularly preferred.

Ester-forming monomers preferably used for the production of a polyester of the at least one component b) are saturated, monovalent or polyvalent alcohols, particularly preferred are aliphatic diols including monoethylene glycol, diethylene glycol, propylene glycol, propane-1,3-diol, butane-1,3-diol, butane-1,4-diol, neopentyl glycol, hexane diol and decane-1,10-diol as well as tris-2-hydroxyethylisocyanurate (THEIC), glycerine, trimethylolethane, trimethylolpropane and pentaerythrite.

The at least one component b) is preferably end-terminated by reaction with a monovalent alcohol or an optionally phosphorus-bearing monocarboxylic acid.

Preferably at least one phosphorus-bearing polyester of the at least one component b) of the halogen-free flame retardant composition has reactive functional groups which are selected from carbon-carbon double bonds, carboxylic acid groups, phosphinic acid groups and hydroxy groups.

Preferably at least one phosphorus-bearing polyester of the at least one component b) has a softening point in the range of between 100° C. and 130° C. Such polyesters are particularly well suited for use in plastics having similar physical properties.

In a preferred embodiment the phosphorus-bearing monomer in component b) has a compound of the following formula (I):

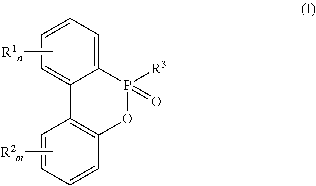

wherein

R¹ and R² are the same or different and are selected from H, alkyl, alkoxy, aryl, aryloxy and arylakyl,

n and m are independently of each other whole numbers of between 1 and 4, and

R³ is a residue with at least one ester-forming group or a residue derived from an unsaturated dicarboxylic acid or anhydride thereof.

A particularly preferred embodiment of the polyester of the at least one component b) has the following formula (II):

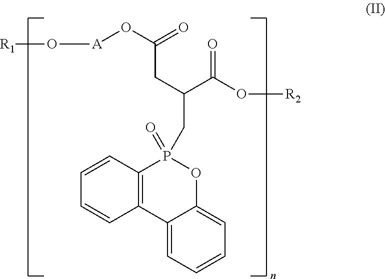

wherein:

R₁ is H, methyl or ethyl,

R₂ is a group of the formula —(CH₂)ₘ—O—R₁,

A is a branched or unbranched alkylene group having between 2 and 6 carbon atoms or selectively substituted aromatic bridge group, preferably —C₂H₄—,

n is a whole number of between 55 and 110, and

m is a whole number of between 1 and 6, preferably 2.

Particularly preferably the components a) and b) are contained in the flame retardant composition in a ratio of between 1:10 and 50:1, preferably between 1:5 and 25:1 and particularly preferably between 1:3 and 10:1. The ratio is given in proportions by weight. The flame retardant composition according to the invention has very good flame-resistant properties over a wide range of quantitative proportions of the components a) and b).

The invention also includes a polymer material which contains the halogen-free flame retardant composition. In particular the halogen-free flame retardant composition is suitable for use in thermoplastics and thermoplastic elastomers.

The flame retardants according to the invention have high thermal stability and do not decompose upon extrusion, they can be well dispersed in polymers, in particular thermoplastics and thermoplastic elastomers. Their low conductivity provides that they are well suited for incorporation into polymers which are used in the field of electrics and electronics. In addition those flame retardants are only little water-soluble and are not washed out of polymers or only little washed out of same.

Preferably the polymer material contains the halogen-free flame retardant composition in an amount of between 5 and 50% by weight, preferably between 10 and 30% by weight, with respect to the total weight of the polymer material with flame retardant composition. By virtue of its particularly good flame-resistant properties the halogen-free flame retardant composition can be used in a plastic in small amounts. Such flame-retarded polymers satisfy very high flame retardant demands in plastics, even in the case of small layer thicknesses of for example 1.6 mm. The small amount of flame retardant compositions used means that the flexibility and processibility of the plastics provided therewith are retained.

Preferred polymer materials are selected from filled and unfilled polyolefins, vinyl polymers, olefin copolymers, olefin-based thermoplastic elastomers, olefin-based crosslinked thermoplastic elastomers, polyurethanes, filled and unfilled polyesters and copolyesters, styrene block copolymers, filled and unfilled polyamides and copolyamides. Examples of polyesters are PET and PBT.

In principle the halogen-free flame retardant compositions according to the invention can be used for all desired polymers. They are particularly suitable as a flame retardant for unfilled and filled or reinforced polyamides, polyesters like polybutylene terephthalate and polyethylene terephthalate, polyolefins like polyethylene and polypropylene, polystyrene, styrene block copolymers like ABS, SBS, SEES, SEPS, SEEPS and MBS, polyurethanes, polyacrylates, polycarbonates, polysulfones, polyetherketone, polyphenylene oxide, polyphenylene sulfide, epoxy resins and so forth. The high resistance of the flame retardant composition according to the invention at high temperatures also makes it suitable for polymer materials which require relatively high processing temperatures.

The plastics provided in that way can be used for example for sheathing cables in conduit systems, for tubes for electric cables, electric components of thermoplastic materials and so forth.

In a preferred embodiment of the invention the polymer material further contains fillers preferably selected from the group consisting of metal hydroxides, preferably alkaline earth metal hydroxides, alkali metal hydroxides and aluminum hydroxide, silicates, preferably sheet silicates, bentonite, alkaline earth metal silicates and alkali metal silicates, carbonates, preferably calcium carbonate like talcum, clay, mica, silica, calcium sulfate, barium sulfate, aluminum hydroxide, magnesium hydroxide, glass fibers, particles and balls, wood dust, cellulose powder, carbon black, graphite, boehmite and dyestuffs.

Those fillers can impart further desired properties to the polymer material. In particular for example by a reinforcement with glass fibers, mechanical stability can be enhanced, the plastic can be colored by the addition of dyestuffs and the price of the plastic can possibly also be reduced.

In a further embodiment the polymer materials contain further additives such as anti-oxidants, light stabilisers, process adjuvant agents, nucleating agents, impact modifiers and in particular compatiblisers and dispersant adjuvants.

As stated above the use of a polymer material which contains the halogen-free flame retardant composition for the production of sheathings for electrically conducting structures, shieldings for electrically conducting structures and housings and components for electrically conducting structures, preferably for the production of cables in conduit systems, tubes for electric cables, electric components of thermoplastic materials is also according to the invention. In particular it is also possible to use a polymer material containing the halogen-free flame retardant composition for the production of housings and components for electric and electronic devices, printed circuit boards, breadboards, electrical connections and switches as well as cable insulations and cable tubes.

Surprisingly a flame retardant composition according to the invention has a flame retardant action which is improved in comparison with the individual components in a large number of different plastics and can be well processed in those plastics. Plastics with the flame retardant composition according to the invention possibly have good mechanical and electrical properties because of a low flame retardant loading.

The flame retardants according to the invention have high thermal stability and do not decompose upon extrusion, they can be well dispersed in polymers, in particular thermoplastics and thermoplastic elastomers. Their low conductivity provides that they are well suited for incorporation into polymers which are used in the field of electrics and electronics. In addition those flame retardants are only little water-soluble and are not washed out of polymers or only little washed out of same.

It is precisely sheathings of cables in electrical conduit systems, tubes for electric cables and electric and electronic components of thermoplastic materials make high demands on the polymer material from which they are made as on the one hand a good flame retardant action has to be ensured as well as good mechanical properties for processing, while on the other hand the polymer material itself, due to additives contained therein, does not contribute to conductivity and provides electrical insulation.

Preferred material thicknesses of the sheathings, shieldings and bases for electrically conducting structures, which are produced with the polymer material containing the halogen-free flame retardant composition, are between about 0.1 mm and 10 mm, preferably between 0.5 mm and 5 mm. It is precisely with those material thicknesses that the flame retardant is particularly effective.

The following examples serve to further describe the invention.

### EXAMPLES

For the tests test bodies of polymer materials with different flame retardant additives were produced. Both flame retardants or flame retardant compositions according to the invention and also not according to the invention and corresponding polymers are involved.

In the production of the test bodies, firstly the respective polymer was extruded. A synchronised double-shaft extruder (L/D=40) from Coperion was used for that purpose. The screw diameter of the extruder was 18 mm. During extrusion with a discharge of 7 kg/h the polymer was gravimetrically metered into the main intake of the extruder by way of a separate metering means. The flame retardant or a flame retardant composition were also gravimetrically added by way of a sidefeeder, having regard to the respective additive amounts. After the conclusion of the extrusion operation the finished polymer material was granulated using a water bath and a strand granulator (Pell-Tec). The material was then pressed using a heatable press to give plates or boards of a thickness of 1.6 mm. Test bodies were cut to shape from the plates or boards and subjected to an UL94 vertical test.

Investigations were carried out in accordance with the specifications of the Underwriter Laboratories, Standard UL94. Five test bodies were used for the test, for each polymer provided with flame retardation. Each test body was clamped in a vertical position. A bunsen burner flame was held twice for 10 seconds against the free end of the test body. Thereafter the respective time until extinction of the flame or extinction of glowing of the test body was measured. At the same time it was established whether drops of the test body, that were set alight, could set fire to cotton (wadding) therebeneath.

The classifications in fire retardant classes V-0 through V-2 are specified as the result. In that respect V-0 means that the total burning duration of 5 tested test bodies was less than 50 seconds and the cotton was not set alight by dropping glowing or burning constituents of the test body. Classification V-1 means that the total burning duration was more than 50 seconds but less than 250 seconds and the cotton was also not set alight. V-2 means that the total burning duration of 5 test bodies was admittedly less than 250 seconds, but the cotton was set alight by dropping constituents of the test bodies in at least one of the 5 tests. The abbreviation NC stands for ‘non-classifiable’ and means that a total burning duration of more than 250 seconds was measured. In many of those cases the test body burnt completely. If there is no information the material could not be processed to afford a test body.

The Table below specifies both the compositions of the polymers and also the results of the above-described flame retardant tests. The polymers used are PBT (unfilled polybutylene terephthalate: Ultradur B4520UN from BASF), PA GF 30 (glass fiber-reinforced polyamide: Durethan BKV 30 H1.0 from Lanxess) and a TPE-E (thermoplastic polyester elastomer: Arnitel EM 400 from DSM).

The following components were used as flame retardant alone or in a combination as the flame retardant composition according to the invention: Ukanol FR 80 (polyester with 9,10-dihydro-9-oxa-10-phospha-phenanthrene-10-oxide-side chains from Schill+Seilacher), Budit 315 (melamine cyanurate from Chemische Fabrik Budenheim) and Budit 3141 (melamine polyphosphate from Chemische Fabrik Budenheim).

The number details respectively concern proportions by weight.

| | Polymer | | | Flame retardation | | | |
|---|---|---|---|---|---|---|---|
| Test | | PA | | Ukanol | Budit | Budit | UL94 |
| No | PBT | GF30 | TPE-E | FR 80 | 315 | 3141 | 1.8 mm |
| 1 | 100 | | | | | | NC |
| 2 | 80 | | | | 20 | | V-2 |
| 3 | 80 | | | 20 | | | |
| 4 | 80 | | | | | 20 | NC |
| 5 | 80 | | | 5 | 15 | | V-2 |
| 6 | 80 | | | 10 | 10 | | V-2 |
| 7 | 80 | | | 15 | 5 | | V-2 |
| 8 | 80 | | | 15 | | 5 | V-2 |
| 9 | 80 | | | 10 | | 10 | V-0 |
| 10 | 80 | | | 5 | | 15 | V-0 |
| 11 | 80 | | | 7.4 | 12.6 | | V-2 |
| 12 | 80 | | | 7.4 | | 12.6 | V-2 |
| 13 | 80 | | | 10 | 5 | 5 | V-2 |
| 14 | 80 | | | 5 | 5 | 10 | V-2 |
| 15 | 80 | | | 5 | 10 | 5 | V-2 |
| 16 | | 100 | | | | | NC |
| 17 | | 80 | | | 20 | | NC |
| 18 | | 80 | | 20 | | | NC |
| 19 | | 80 | | 5 | 15 | | V-2 |
| 20 | | 80 | | 10 | 10 | | V-2 |
| 21 | | 80 | | 15 | 5 | | V-2 |
| 22 | | | | | 25 | | V-2 |
| 23 | | | | | 30 | | V-1 |
| 24 | | | | 25 | | | |
| 25 | | | | 2.5 | 22.5 | | V-0 |
| 26 | | | | 5 | 20 | | V-0 |
| 27 | | | | 7.5 | 17.5 | | V-0 |

An effect is clearly demonstrated from the specified tests with the combination of a polyester according to component b) (Ukanol FR 80) and a compound according to component a) (Budit 315 and Budit 3141 respectively). If such a combination was used as flame retardation classification could always be effected.

While PBT cannot be classified or cannot be processed when processing with only one flame retardant or is classified in stage V-2, the fire retardation class V-0 can be achieved with a combination of Budit 315 and Ukanol, with the same amount of flame retardation used.

A similar effect is demonstrated with PA GF 30 which cannot be classified with only one flame retardation component, but is classified in stage V-2 with the combination of Ukanol FR 80 and Budit 315. When using a combination of 12% Ukanol FR 80 and 12% Budit 3141 it is even possible to achieve a classification of V-0 for PA GFR 30.

The synergistic action of the components a) and b) is particularly clearly apparent from the tests with TPE-E. That material cannot be processed with the addition of exclusively Ukanol FR 80 (component b)). With an addition of Budit 315 it is only possible to achieve the classification V-1 with an increase in the amount of flame retardant while the combination of Budit 315 with a small amount of Ukanol FR 80 already leads to the classification V-0.

In addition the total burning time can be markedly reduced in comparison with a single flame retardant composition by the combination of a component a) and b) within a classification (data not shown).

1. A halogen-free flame retardant composition comprising
at least one component (a) selected from the group consisting of nitrogen bases, melamine derivatives, phosphates, pyrophosphates, polyphosphates, organic and inorganic phosphinates, organic and inorganic phosphonates and derivatives of the aforementioned compounds, and
at least one component (b) selected from phosphorus-bearing polyesters which can be obtained by reaction of phosphorus-bearing monomers with each other and/or with ester-forming monomers, wherein the phosphorus-bearing monomer is selected from addition products of 9,10-dihydro-9-oxa-10-phospha-phenanthrene-10-oxide (DOPO) and ring-substituted derivatives of 9,10-dihydro-9-oxa-10-phospha-phenanthrene-10-oxide to unsaturated compounds from the group of monovalent and polyvalent carboxylic acids and anhydrides thereof, monovalent and polyvalent alcohols and hydroxycarboxylic acids and wherein the ester-forming monomer is selected from the group consisting of saturated and unsaturated, monovalent and polyvalent alcohols or mixtures thereof, saturated and unsaturated carboxylic acid anhydrides and saturated and unsaturated, monovalent and polyvalent carboxylic acids.

2. The halogen-free flame retardant composition according to claim 1, wherein the at least one component a) is selected from ammonium polyphosphate, ammonium polyphosphate particles which are coated with melamine, melamine resin, melamine derivatives, silanes, siloxanes or polystyrenes and/or which are coated and crosslinked, as well as 1,3,5-triazine compounds, including melamine, melam, melem, melon, ammeline, ammelide, 2-ureidomelamine, acetoguanamine, benzoguanamine, diaminophenyltriazine, melamine salts and adducts, melamine cyanurate, melamine borate, melamine orthophosphate, melamine pyrophosphate, dimelamine pyrophosphate and melamine polyphosphate, oligomeric and polymeric 1,3,5-triazine compounds and polyphosphates of 1,3,5-triazine compounds, guanine, piperazine phosphate, piperzine polyphosphate, ethylene diamine phosphate, pentaerythritol, borophosphate, 1,3,5-trihydroxyethylisocyanaurate, 1,3,5-triglycidylisocyanaurate, triallylisocyanurate and derivatives of the aforementioned compounds.

3. The halogen-free flame retardant composition according to claim 1, wherein at least two different components a) are contained, wherein at least one component a) is selected from ammonium polyphosphate and derivatives thereof or melamine phosphate derivatives and at least one other component a) is a nitrogen base different from the first component.

4. The halogen-free flame retardant composition according to claim 1, wherein at least one phosphorus-bearing polyester of the at least one component b) has a mean degree of polymerisation Pₙ of at least 55.

5. The halogen-free flame retardant composition according to claim 1, wherein at least one phosphorus-bearing polyester of the at least one component b) has a mean molecular weight Mₙ of more than 1000 g/mol.

6. The halogen-free flame retardant composition according to claim 1, wherein at least one phosphorus-bearing polyester of the at least one component b) has reactive functional groups which are selected from carbon-carbon double bonds, carboxylic acid groups, phosphinic acid groups and hydroxy groups.

7. The halogen-free flame retardant composition according to claim 1, wherein at least one phosphorus-bearing polyester of the at least one component b) has a softening point in the range of between 100° C. and 130° C.

8. The halogen-free flame retardant composition according to claim 1, wherein the phosphorus-bearing monomer in component b) has a compound of the following formula (I): 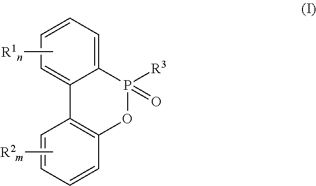
wherein
R¹ and R² are the same or different and are selected from H, alkyl, alkoxy, aryl, aryloxy and arylakyl,
n and m are independently of each other whole numbers of between 1 and 4, and
R³ is a residue with at least one ester-forming group or a residue derived from an unsaturated dicarboxylic acid or anhydride thereof.

9. The halogen-free flame retardant composition according to claim 1, wherein the components a) and b) are contained in the flame retardant composition in a ratio of between 1:10 and 50:1.

10. A polymer material which contains the halogen-free flame retardant composition according to claim 1.

11. The polymer material according to claim 10, wherein it contains the halogen-free flame retardant composition in an amount of between 5 and 50% by weight with respect to the total weight of the polymer material with flame retardant composition.

12. The polymer material according to claim 10, wherein the polymer material is selected from filled and unfilled polyolefins, vinyl polymers, olefin copolymers, olefin-based thermoplastic elastomers, olefin-based crosslinked thermoplastic elastomers, polyurethanes, filled and unfilled polyesters and copolyesters, styrene block copolymers, filled and unfilled polyamides and copolyamides.

13. The polymer material according to claim 10, wherein the polymer material further contains fillers preferably selected from the group consisting of metal hydroxides, preferably alkaline earth metal hydroxides, alkali metal hydroxides and aluminum hydroxide, silicates, preferably sheet silicates, bentonite, alkaline earth metal silicates and alkali metal silicates, carbonates, preferably calcium carbonate like talcum, clay, mica, silica, calcium sulfate, barium sulfate, aluminum hydroxide, magnesium hydroxide, glass fibers, particles and balls, wood dust, cellulose powder, carbon black, graphite, boehmite and dyestuffs.

14. A method of using the halogen-free flame retardant composition according to claim 1 comprising adding the halogen-free flame retardant composition to a polymer material to be used in production of sheathings for electrically conducting structures, shieldings for electrically conducting structures, and housings and components for electrically conducting structures, preferably for the production of cables in conduit systems, tubes for electric cables, electric components of thermoplastic materials.

15. A method of making a sheathing, shielding, housing, or component for electrically conducting structures, comprising adding the halogen-free flame retardant composition according to claim 1 to a polymer material and using the polymer material in forming the sheathing, shielding, housing, or component.
